(19) United States
(12) Patent Application Publication
(10) Pub. No.: US 2021/0082209 A1
(43) Pub. Date: Mar. 18, 2021

(54) USING NON-OBD CODES WITH OBD CODES IN WIRELESS COMMUNICATION NETWORKS

(71) Applicant: T-Mobile USA, Inc., Bellevue, WA (US)

(72) Inventors: Gaviphat Lekutai, Kirkland, WA (US); Ryan David Colter, Bellevue, WA (US)

(73) Assignee: T-Mobile USA, Inc.

(21) Appl. No.: 16/572,097

(22) Filed: Sep. 16, 2019

(51) Int. Cl. G07C 5/00; B60W 50/02; B60W 50/04; B60W 40/12

(52) U.S. Cl. CPC G07C 5/008; B60W 50/0205; B60W 50/04; B60W 2050/046; B60W 2530/20; B60W 2560/02; B60W 2422/50; B60W 40/12

(57) ABSTRACT

Systems and methods discussed herein are directed to combining non-onboard diagnostic (OBD) codes with OBD codes to provide a list of codes that may be used to provide information to a user regarding a vehicle. For example, an auxiliary monitoring device may be included in a vehicle in the form of one or more sensors, e.g., cameras, image sensors, movement sensors, audio sensors, variable reluctance (VR) sensors, infrared (IR) sensors, odor sensors, etc., that may collect vehicle information that is not available through the vehicle's OBD port. The auxiliary monitoring device may obtain the information and convert the information into a corresponding non-OBD code. The auxiliary monitoring device thus complements an OBD monitoring device included in the vehicle that is coupled to the vehicle's OBD port to obtain OBD codes therefrom.

### BACKGROUND

There currently are monitoring devices that may communicate with an on-board diagnostic (OBD) port of a vehicle. The monitoring devices may obtain OBD codes via the OBD port. The OBD codes may provide diagnostic information and status information for various aspects of the vehicle. For example, certain codes relate to the appearance of a “check engine” indicator on the vehicle's dashboard display. OBD codes that may indicate the problem associated with the display of the “check engine” indicator provide information as to the cause. Other examples of information provided by OBD codes may include Global Positioning System (GPS), direction, movement sensing, vehicle dashboard information (e.g., fuel level, heat level, speed, acceleration, alarm, etc.), etc.

The monitoring devices may obtain the OBD codes and process them to provide information to an electronic device of a user. For example, the portable electronic device may be in the form of a smartphone. The smartphone may include an applet that receives information from a processing service that process received OBD codes from the monitoring device. Thus, the monitoring device may send an OBD code to the processing service that processes the OBD code, where the OBD code relates to a low engine oil level for the vehicle's engine. Thus, the processing service may send a message to the electronic device and the electronic device's display may display a message “low engine oil” or “check engine oil.” However, while there are many OBD codes that provide diagnostic and other types of information, many pieces of information are not available using OBD codes. For example, information related to the interior of the vehicle, operating status of various components of the vehicle, physical status of the vehicle, etc., may not be available using OBD codes obtained via the OBD port. Furthermore, older vehicles may have limited OBD codes that may be obtained via the OBD port.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1A schematically illustrates an example arrangement of a wireless communication network and a vehicle, in accordance with various configurations.

FIG. 1B schematically illustrates a flow of information from an auxiliary monitoring device of the vehicle of FIG. 1, in accordance with various configurations.

FIG. 2 is a flow diagram of an example process for transmitting information related to OBD codes and non-OBD codes from a vehicle to an electronic device within a wireless communication network, in accordance with various configurations.

FIG. 3 schematically illustrates a component level view of an example electronic device configured for use in the wireless communication network of FIG. 1, in accordance with various configurations.

FIG. 4 schematically illustrates a component level view of a server configured for use with the example arrangements of FIGS. 1A and 1B to provide various services, in accordance with various configurations.

### DETAILED DESCRIPTION

Techniques and architecture are described herein for combining non-onboard diagnostic (OBD) codes with OBD codes to provide a list of codes that may be used to provide information to a user regarding a vehicle. For example, an auxiliary monitoring device may be included in a vehicle in the form of one or more sensors, e.g., cameras, image sensors, movement sensors, audio sensors, virtual reality (VR) cameras, augmented reality (AR) cameras, infrared (IR) sensors, odor sensors, etc., that may collect vehicle information that is not available through the vehicle's OBD port. The auxiliary monitoring device may obtain the information and convert the information into a corresponding non-OBD code. The auxiliary monitoring device complements an OBD monitoring device included in the vehicle that is coupled to the vehicle's OBD port to obtain OBD codes therefrom.

In particular, the auxiliary monitoring device may obtain information related to, for example, a status of the vehicle (e.g., the vehicle is moving when it should not be, has been bumped, etc.), a status of a reading light within the vehicle, a status of a headlight of the vehicle, an alarm with respect to the vehicle, the presence of something alive, e.g., an animal, a child, etc., within the vehicle, mileage information, temperature information, navigator information, map information, etc. For example, the auxiliary monitoring device may be in the form of a camera and may gather information from the vehicle's dashboard display related to, for example, fuel level, position of a fuel cap on the vehicle, tire pressure, battery level, temperature, etc.

When information is obtained via the auxiliary monitoring device, the auxiliary monitoring device may send an appropriate non-OBD code over a wireless communication network to a processing service. In configurations, the processing service may be provided by one or more servers of the wireless communication network. In some configurations, the processing service may be part of a network of computing resources, e.g., a “cloud” network. The processing service may include a list of OBD codes and a list of non-OBD codes. In configurations, the processing service may include a combined list of OBD codes and non-OBD codes. The processing service may then determine, based upon the received non-OBD code, information related to the vehicle.

The processing service may forward the information to an electronic device of a person of interest. For example, the person of interest may be the owner of the vehicle, a spouse of the owner of the vehicle, an employer of a user of the vehicle, etc. The electronic device may then, based upon the received information from the processing service, display a message regarding information on a display of the electronic device. Additionally, an alarm, either audible or visible, may also be generated by the electronic device.

In configurations, the auxiliary monitoring device may include a radio and thus, may communicate directly with the processing service via the wireless communication network. The processing service may communicate with the electronic device via the wireless communication network. In configurations, the auxiliary monitoring device may provide any generated non-OBD codes to the OBD monitoring device via, for example, Wi-Fi, Bluetooth, a wired connection, etc. The OBD monitoring device may then forward the non-OBD codes, along with any generated OBD codes, to the processing service.

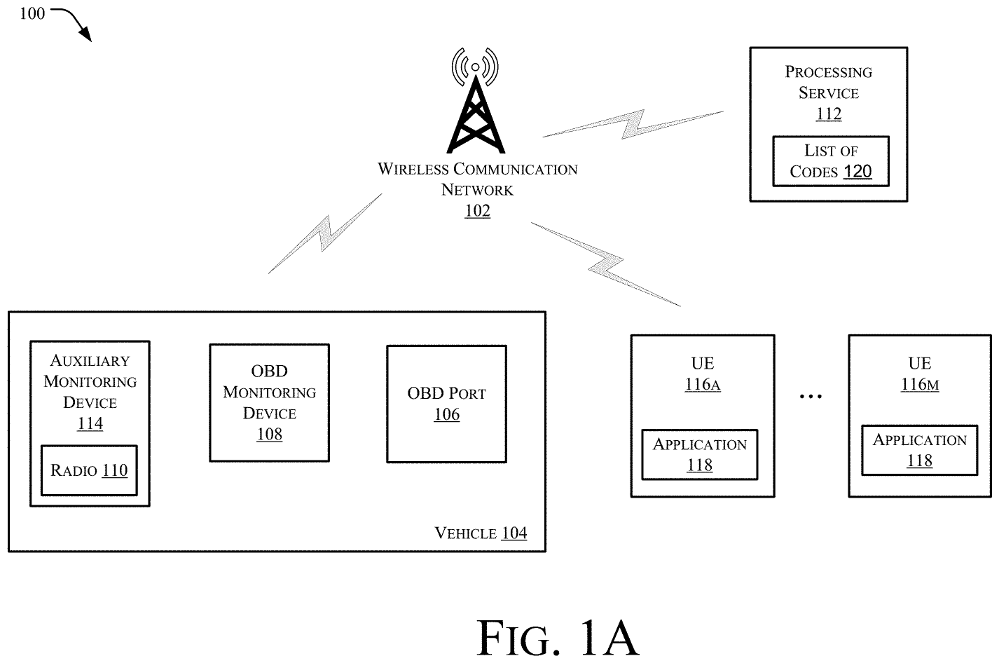

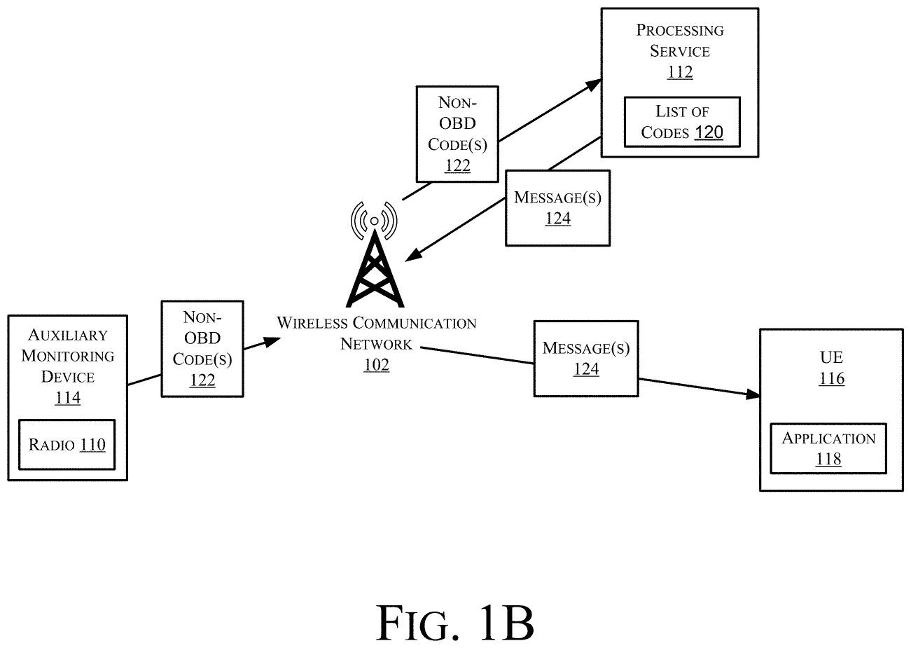

FIG. 1A schematically illustrates an example arrangement 100 of a wireless communication network 102. In the example of FIG. 1A, the wireless communication network 102 is represented by a base station. As is known, the wireless communication network 102 also includes numerous other components not illustrated in FIG. 1A for clarity purposes.

The example arrangement 100 also includes a vehicle 104. The vehicle 104 includes an on-board diagnostic (OBD) port 106.

The OBD port 106 is in communication with one or more vehicle components that provide information with respect to the vehicle 104. For example, the OBD port 106 may receive information with respect to electronics of the vehicle 104, an engine of the vehicle 104, etc. Generally, the OBD port 106 relays received information to devices via OBD codes. The OBD codes represent information with respect to the vehicle 104. For example, an OBD code may indicate that the vehicle's oil level is low. Additionally, if the check engine light appears on a dashboard display of the vehicle 104, an OBD code may provide an indication as to why the check engine light has appeared on the vehicle's dashboard display.

The vehicle further includes an OBD monitoring device 108 that is communicatively coupled with the OBD port 106. In configurations, the communicative coupling is a physical or wired coupling. In other configurations, the OBD monitoring device 108 is communicatively coupled to the OBD port 106 via a wireless connection. The OBD monitoring device 108 includes a radio 110 that may be used to communicate with the wireless communication network 102. For example, when the OBD monitoring device 108 receives an OBD code from the OBD port 106, the OBD monitoring device 108 may forward the OBD code to a processing service 112 via the wireless communication network 102, as will be described further herein.

The vehicle 104 also includes one or more auxiliary monitoring devices 114. The one or more auxiliary monitoring devices may be in the form of one or more sensors, e.g., cameras, image sensors, movement sensors, audio sensors, virtual reality (VR) cameras, augmented reality cameras, infrared (IR) sensors, odor sensors, etc. The one or more auxiliary monitoring devices 114 may be located inside the vehicle 104 for example, on a steering wheel or steering column (e.g., facing a dashboard display and/or an operator of the vehicle), arm rest, ceiling, floor, door, window, etc. The one or more auxiliary monitoring devices 114 may sense, for example, images, sounds, odors, etc., and convert the information into useful non-OBD codes similar to OBD codes. In configurations, the auxiliary monitoring device 114 may be a central auxiliary monitoring device in communication with one or more sensors that provide information to the central auxiliary monitoring device, which may then generate non-OBD codes.

The one or more auxiliary monitoring devices 114 may obtain information related to, for example, a status of the vehicle 104 (e.g., the vehicle 104 is moving when it should not be, the vehicle has been bumped, etc.), a status of a reading light within the vehicle 104, a status of a headlight of the vehicle 104, an alarm with respect to the vehicle 104, the presence of something alive, e.g., an animal, a child, etc., within the vehicle 104, mileage information, temperature information, navigator information, map information, etc. For example, as previously noted, an auxiliary monitoring device 114 may be in the form of a camera facing the vehicle's dashboard display and may gather information from the vehicle's dashboard display related to, for example, fuel level, position of a fuel cap on the vehicle, tire pressure, battery level, temperature, speed, etc.

The example arrangement in FIG. 1A further includes the processing service 112. In configurations, the processing service 112 is a computing service consisting of one or more processors or servers. The processing service may be located in a dedicated location, e.g., part of the wireless communication network 102, or may be part of a networked computing service, also referred to as a “cloud” system, e.g., data centers available to many users over the Internet.

The example arrangement 100 also includes one or more user equipments (UEs) 116a-116m, which may be referred to singularly herein as UE 116 or collectively herein as UEs 116. The UEs 116 are generally in the form of electronic devices configured to communicate with other electronic devices via the wireless communication network 102. Examples of electronic devices include, without limitation, a mobile phone (e.g., a smartphone), a tablet computer, a laptop computer, a portable digital assistant (PDA), a wearable computer (e.g., electronic/smart glasses, a smart watch, fitness trackers, etc.), a networked digital camera, a motor vehicle, and/or similar mobile devices. The UEs may include an application or applet 118 configured to allow the UEs 116 to receive information from the processing service 112.

In configurations, the OBD monitoring device 108 and the auxiliary monitoring device 114 monitor the vehicle 104. The OBD monitoring device 108 receives OBD codes from the OBD port 106 and provides them, via the wireless communication network 102, to the processing service 112. The processing service 112 may process the received OBD codes based upon a list 120 of OBD codes to generate information. The processing service 112 may provide the information in the form of one or more messages, alarms, notifications, etc., to one or more of the UEs 116. For example, if the OBD monitoring device 108 receives an OBD code related to engine oil level of the vehicle 104, upon processing the OBD code, the processing service 112 may send a message to one or more of the UEs 116 to “check the engine oil” or “low engine oil.”

The auxiliary monitoring device 114 may determine other information for which there are no OBD codes. Based on the information, the auxiliary monitoring device 114 may then provide non-OBD codes, via the wireless communication network 102, directly to the processing service 112 via a radio 110. The processing service 112 may process the non-OBD codes using the list 120 to provide the information related to the non-OBD codes in the form of one or more messages to one or more of the UEs 116 based on the non-OBD codes. The messages based on non-OBD codes may be combined by the processing service 112 with messages based on OBD codes. Thus, the list 120 may be a combined list that includes OBD codes and non-OBD codes. In configurations, the processing service 112 may include a separate list of OBD codes and a separate list of non-OBD codes. As an example, the non-OBD code may indicate that an interior light is on within the vehicle 104 when the vehicle is not operating. The processing service 112 may then provide the message to the one or more UEs 116 indicating that an interior light is on in the vehicle 104.

FIG. 1B schematically illustrates a flow of information from the auxiliary monitoring device 114. The auxiliary monitoring device 114 may gather information with respect to the vehicle 104. Based on the information gathered, the auxiliary monitoring device 114 may generate and forward the appropriate non-OBD codes 122, via the wireless communication network 102, to the processing service 112. The processing service 112 may then generate and send corresponding messages 124 based on the non-OBD codes 122 to one or more UEs 116 via the wireless communication network 102. For example, if the auxiliary monitoring device 114 has detected the presence of something moving within the vehicle 104, e.g., a pet, a child, etc., the message may indicate to the one or more UEs 116 that something alive is moving within the vehicle 104. In configurations, the non-OBD codes 122 may be combined with OBD codes received from the OBD monitoring device 108 by the processing service 112, before or after processing the codes. One or more messages 124 may then be generated by the processing service 112 related to all or part of the non-OBD codes 122 and/or OBD codes and transmitted to one or more UEs 116.

As an example, the non-OBD codes 122 may relate to operation of the vehicle 104. For example, one of the UEs 116 may be the UE of a parent. The auxiliary monitoring device 114 may be in the form of a camera, for example, mounted on the steering column of the vehicle 104 and facing the dashboard display of the vehicle 104. The camera may detect the speed of the vehicle 104 and may send a non-OBD code 122 to the processing service 112 indicating the speed or speed range of the vehicle 104. The processing service 112 may, based on the non-OBD code 122, generate and send a message 124 to the UE 116 that informs the parent the speed or speed range at which the child is operating the vehicle 104.

In configurations, the one or more auxiliary monitoring devices 114 may communicate directly, via the wireless communication network 102, using their own radios 110, with the processing service 112. In other configurations, the one or more auxiliary monitoring devices 114 may communicate with the OBD monitoring device 108 using, for example, Wi-Fi, Bluetooth, or a wired connection to provide the non-OBD codes 122 to the OBD monitoring device 108. The OBD monitoring device 108 may then forward non-OBD codes 122, along with any OBD codes, to the processing service 112.

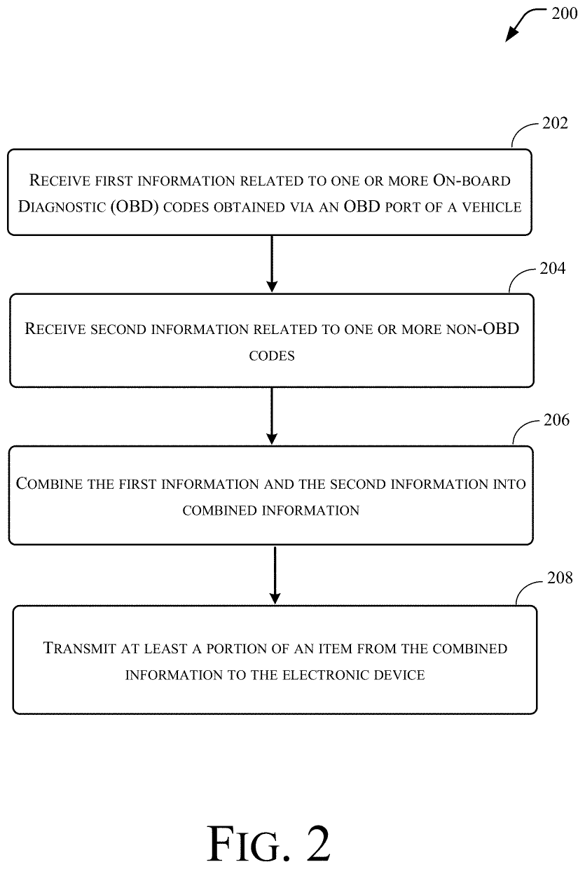

FIG. 2 is a flow diagram of an example process 200 for transmitting information related to OBD codes and non-OBD codes from a vehicle, e.g., vehicle 104, to an electronic device, e.g., UEs 116, within a wireless communication network, e.g., wireless communication network 102. At block 202, first information related to one or more on-board diagnostic (OBD) codes obtained via an OBD port of a vehicle is received. The first information is received from the vehicle via the wireless communication network. At block 204, second information related to one or more non-OBD codes is received. The second information is received from the vehicle via the wireless communication network.

At block 206, the first information and the second information are combined into combined information. At block 208, at least a portion of an item from the combined information is transmitted to the electronic device.

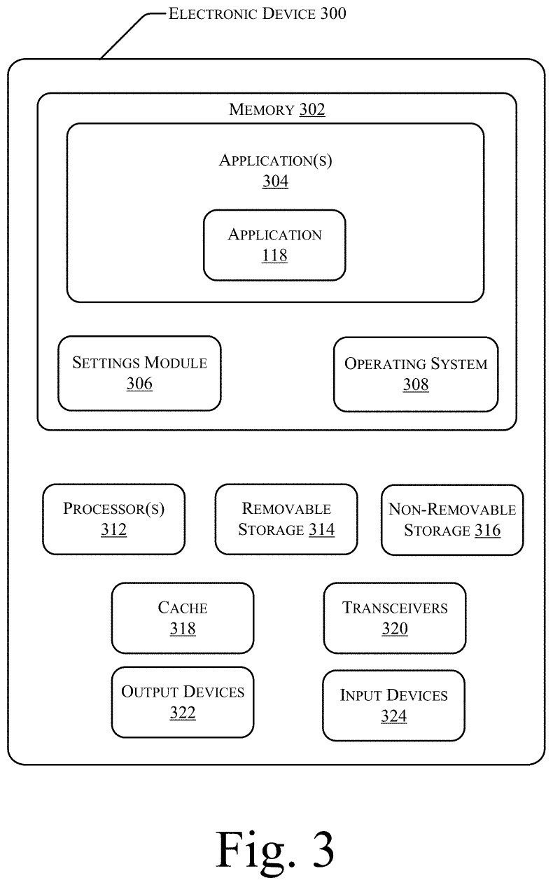

FIG. 3 schematically illustrates a component level view of an example electronic device 300, such as UEs 116, configured to function within wireless communication network 102. The electronic device 300 may include more or less components depending on the type of electronic device. As illustrated, the electronic device 300 comprises a system memory 302, e.g., computer-readable media, storing application(s) 304. For example, the applications(s) 304 may include application 118. The mobile device also comprises a settings module 306, and an operating system 308. Also, the electronic device 300 includes processor(s) 312, a removable storage 314, a non-removable storage 316, cache 318, transceivers 320, output device(s) 322, and input device(s) 324. In various implementations, system memory 302 is volatile (such as RAM), non-volatile (such as ROM, flash memory, etc.) or some combination of the two. In some implementations, the processor(s) 312 is a central processing unit (CPU), a graphics processing unit (GPU), or both CPU and GPU, or any other sort of processing unit.

The electronic device 300 may also include additional data storage devices (removable and/or non-removable) such as, for example, magnetic disks, optical disks, or tape. Such additional data storage may include removable storage 314 and non-removable storage 316. Additionally, the electronic device 300 includes cache 318.

Non-transitory computer-readable media may include volatile and nonvolatile, removable and non-removable tangible, physical media implemented in technology for storage of information, such as computer readable instructions, data structures, program modules, or other data. System memory 302, removable storage 314, non-removable storage 316 and cache 318 are all examples of non-transitory computer-readable media. Non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information and which can be accessed by the electronic device 300. Any such non-transitory computer-readable media may be part of the electronic device 300. The processor(s) 312 may be configured to execute instructions, which may be stored in the non-transitory computer-readable media or in other computer-readable media accessible to the processor(s) 312.

In some implementations, the transceivers 320 include any sort of transceivers known in the art. For example, the transceivers 320 may include a radio transceiver that performs the function of transmitting and receiving radio frequency communications via an antenna (not shown). Also, or alternatively, the transceivers 320 may include wireless modem(s) to facilitate wireless connectivity with other computing devices. Further, the transceivers 320 may include wired communication components, such as an Ethernet port, for communicating with other networked devices.

In some implementations, the output devices 322 include any sort of output devices known in the art, such as a display (e.g., a liquid crystal display), speakers, a vibrating mechanism, or a tactile feedback mechanism. Output devices 322 also include ports for one or more peripheral devices, such as headphones, peripheral speakers, or a peripheral display.

In various implementations, input devices 324 include any sort of input devices known in the art. For example, input devices 324 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 324 may be used to enter preferences of a user of the electronic device 300 to define how the user wishes certain calls from third parties to be handled by the wireless communication network, as previously described herein.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Memory 302 is an example of computer storage media.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1A, 1B and 2. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

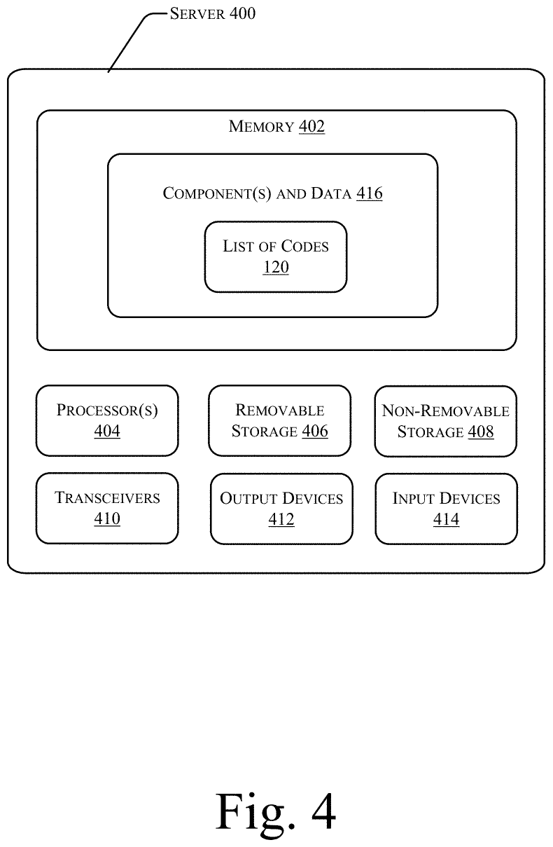

FIG. 4 illustrates a component level view of a server 400 configured for use within a wireless communication network, e.g., wireless communication network 102 in order to provide various services for and/or within the wireless communication network, according to the techniques described herein. For example, one or more servers 400 may be configured to operate as the processing service 112. As illustrated, the server 400 comprises a system memory 402 that may store one or more components and/or applications and data 416 for interacting with electronic device 300, e.g., UEs 116, or other electronic devices that may be configured as connected devices, as described herein. Also, the server 400 may include processor(s) 404, a removable storage 406, a non-removable storage 408, transceivers 410, output device(s) 412, and input device(s) 414.

In various implementations, system memory 402 is volatile (such as RAM), non-volatile (such as ROM, flash memory, etc.), or some combination of the two. In some implementations, the processor(s) 404 is a central processing unit (CPU), a graphics processing unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 406 and non-removable storage 408. The one or more of the memory 402, the removable storage 406 and/or the non-removable 408 may include module(s) and data 416 (illustrated in the memory 402). For example, the data 416 may include the list 120 of OBD codes and non-OBD codes. The module(s) and data 416 may also include instructions executable by, for example, the processor(s) 404.

Non-transitory computer-readable media may include volatile and nonvolatile, removable and non-removable tangible, physical media implemented in technology for storage of information, such as computer readable instructions, data structures, program modules, or other data. System memory 402, removable storage 406 and non-removable storage 408 are all examples of non-transitory computer-readable media. Non-transitory computer-readable media include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 410 include any sort of transceivers known in the art. For example, the transceivers 410 may include wired communication components, such as an Ethernet port, for communicating with other networked devices. Also, or instead of, the transceivers 410 may include wireless modem(s) to facilitate wireless connectivity with other computing devices. Further, the transceivers 410 may include a radio transceiver that performs the function of transmitting and receiving radio frequency communications via an antenna.

In some implementations, the output devices 412 include any sort of output devices known in the art, such as a display (e.g., a liquid crystal display), speakers, a vibrating mechanism, or a tactile feedback mechanism. Output devices 412 also include ports for one or more peripheral devices, such as headphones, peripheral speakers, or a peripheral display.

In various implementations, input devices 414 include any sort of input devices known in the art. For example, input devices 414 may include a camera, a microphone, a keyboard/keypad, a computer mouse, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Memory 302 and memory 402 are examples of computer storage media.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1A, 1B and 2. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a vehicle via a wireless communication network, first information related to one or more on-board diagnostic (OBD) codes obtained via an OBD port of the vehicle;
receiving, from the vehicle via the wireless communication network, second information related to one or more non-OBD codes;
combining the first information and the second information into combined information; and
transmitting at least a portion of an item from the combined information to an electronic device.

2. The method of claim 1, wherein the second information comprises one or more of fuel level information, tire pressure information, battery level information, temperature information, fuel cap status information, interior light status information, exterior light status information, mileage information, temperature information, navigator information, map information, or vehicle occupancy information.

3. The method of claim 1, wherein receiving the second information comprises receiving the second information from one or more sensors located within the vehicle.

4. The method of claim 3, wherein the one or more sensors comprises a camera mounted on a steering wheel of the vehicle.

5. The method of claim 4, wherein the camera is configured to capture image data associated with a dashboard of the vehicle.

6. The method of claim 3, wherein the one or more sensors comprise one or more of a camera, an image sensor, a motion sensor, an audio sensor, a virtual reality camera, an augmented reality camera, or an odor sensor.

7. The method of claim 1, wherein:
receiving, from the vehicle via the wireless communication network, information related to one or more OBD codes obtained via the OBD port of the vehicle comprises receiving, from a monitoring device located in the vehicle via the wireless communication network, information related to one or more OBD codes obtained via the OBD port of the vehicle; and
receiving, from the vehicle via the wireless communication network, information related to one or more non-OBD codes comprises receiving, from the monitoring device located in the vehicle via the wireless communication network, information related to one or more non-OBD codes.

8. The method of claim 1, wherein receiving the second information comprises receiving, from a radio of the vehicle via the wireless communication network, information related to the second information.

9. The method of claim 8, wherein receiving the first information comprises receiving, from a monitoring device located in the vehicle and via the wireless communication network, the first information.

10. The method of claim 8, wherein receiving the first information comprises receiving, from the radio of the vehicle and via the wireless communication network, the first information.

11. An apparatus comprising:
one or more processors; and
a non-transitory storage medium comprising instructions stored thereon, the instructions being executable by the one or more processors to cause the processors to perform one or more actions comprising:
receiving, from a vehicle via a wireless communication network, first information related to one or more on-board diagnostic (OBD) codes obtained via an OBD port of the vehicle;
receiving, from the vehicle via the wireless communication network, second information related to one or more non-OBD codes;
combining the first information and the second information into combined information; and
transmitting at least a portion of an item from the combined information to an electronic device.

12. The apparatus of claim 11, wherein the second information comprises one or more of fuel level information, tire pressure information, battery level information, temperature information, fuel cap status information, interior light status information, exterior light status information, mileage information, temperature information, navigator information, map information, or vehicle occupancy information.

13. The apparatus of claim 11, wherein receiving the second information comprises receiving the second information from one or more sensors located within the vehicle.

14. The apparatus of claim 13, wherein the one or more sensors comprises a camera mounted on a steering wheel of the vehicle.

15. The apparatus of claim 14, wherein the camera is configured to capture image data associated with a dashboard of the vehicle.

16. The apparatus of claim 13, wherein the one or more sensors comprise one or more of a camera, an image sensor, a motion sensor, an audio sensor, a variable reality camera, an augmented reality camera, or an odor sensor.

17. The apparatus of claim 11, wherein:
receiving, from the vehicle via the wireless communication network, information related to one or more OBD codes obtained via the OBD port of the vehicle comprises receiving, from a monitoring device located in the vehicle via the wireless communication network, information related to one or more OBD codes obtained via the OBD port of the vehicle; and
receiving, from the vehicle via the wireless communication network, information related to one or more non-OBD codes comprises receiving, from the monitoring device located in the vehicle via the wireless communication network, information related to one or more non-OBD codes.

18. A non-transitory storage medium comprising instructions stored thereon, the instructions being executable by one or more processors to perform actions comprising:
receiving, from a vehicle via a wireless communication network, first information related to one or more on-board diagnostic (OBD) codes obtained via an OBD port of the vehicle;
receiving, from the vehicle via the wireless communication network, second information related to one or more non-OBD codes;
combining the first information and the second information into combined information; and
transmitting at least a portion of an item from the combined information to an electronic device.

19. The non-transitory storage medium of claim 18, wherein the second information comprises one or more of fuel level information, tire pressure information, battery level information, temperature information, fuel cap status information, interior light status information, exterior light status information, mileage information, temperature information, navigator information, map information, or vehicle occupancy information.

20. The non-transitory storage medium of claim 18, wherein:
receiving, from the vehicle via the wireless communication network, information related to one or more OBD codes obtained via the OBD port of the vehicle comprises receiving, from a monitoring device located in the vehicle via the wireless communication network, information related to one or more OBD codes obtained via the OBD port of the vehicle; and
receiving, from the vehicle via the wireless communication network, information related to one or more non-OBD codes comprises receiving, from the monitoring device located in the vehicle via the wireless communication network, information related to one or more non-OBD codes.
